(19) United States
(12) Patent Application Publication
(10) Pub. No.: US 2005/0194551 A1
(43) Pub. Date: Sep. 8, 2005

(54) Corona shield, and method of making a corona shield

(75) Inventors: Bernhard Klaussner, Nurnberg (DE); Christoph Meyer, Erfurt (DE); Volker Muhrer, Furth (DE); Alexander Maurer, Nurnberg (DE); Christian Russel, Jena (DE); Klaus Schafer, Nurnberg (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 11/014,631

(22) Filed: Dec. 16, 2004

Related U.S. Application Data
(63) Continuation of application No. PCT/DE03/01864, filed on Jun. 5, 2003.

(30) Foreign Application Priority Data
Jun. 18, 2002 (DE) 102 27 227.1

(51) Int. Cl. H02K 15/10; G21K 1/00

(52) U.S. Cl. 250/505.1

(57) ABSTRACT

A corona shield for an electrical machine includes a substrate with a coating or a fabric or non-woven fabric made of filaments which are coated, wherein the coating contains electrically conductive inorganic material.

### CROSS-REFERENCES TO RELATED APPLICATIONS

This application is a continuation of prior filed copending PCT International application no. PCT/DE03/01864, filed Jun. 5, 2003, which designated the United States and on which priority is claimed under 35 U.S.C. §120, and which claims the priority of German Patent Application, Serial No. 102 27 227.1, filed Jun. 18, 2002, pursuant to 35 U.S.C. 119(a)-(d).

### BACKGROUND OF THE INVENTION

The present invention relates, in general, to a corona shield for an electric machine, and to a method of making a corona shield.

Nothing in the following discussion of the state of the art is to be construed as an admission of prior art.

A typical corona shield includes at least a fabric or a non-woven fabric made of glass or polyester. Examples of fabrics are referred to in DIN-standards (German Industrial Standard) DIN 16740 and DIN 16741 from the year 1976 (January). DIN 16740 relates to a textile glass fabric for electronic applications, whereas DIN 16741 relates to textile glass fabric bands with firm selvedges for electronic applications. The fabrics are used, for example, as substrate for impregnating fluid to provide electric properties. While impregnation enables the production of a corona shield, there are many drawbacks associated therewith. The corona shield produced through impregnation is only partially hardened. During the impregnation of the electric machine, also called VPI process (Vacuum Pressure Impregnation), the electric conductivity of the partially hardened corona shield is adversely affected and may change.

A corona shield may also be made, for example, by a chemical reduction process, as disclosed in U.S. Pat. No. 3,639,113. The need for a reduction process is not only disadvantageous but also limits the establishment of electrical conductivity to only a top layer of the corona shield. Thus, electric conductivity cannot be realized across the entire cross section. Moreover, the top layers of the corona shield can get damaged, when the electric conductors, on which the corona shield is attached, are installed, normally by hammering, into the slots of an electric machine. Since only the top layers of the corona shield are electrically conductive, the electric conductivity of the corona shield will thus be reduced in an undesired way.

Typically, corona shield is produced by using as base material a fabric band of glass or polyester which is non-conducting and soaked in a solvent. Corona shielding is normally differentiated between OCS, short for outer corona shield, and ECS, short for end corona shield. When ECS is involved, silicon carbide (SiC) in combination with an organic binder like resin and the glass fabric is used to produce the corona shield. OCS is made by using the glass fabric together with soot and/or graphite and an organic binder such as resin. Conventional corona shields include organic binder material like resin. A drawback of organic binders is their poor resistance to thermal stress which can result in a change of positioning of the electrically conductive materials within the binder so that ultimately the electric conductivity is altered. Contact between the electrically conducting materials (SiC, soot, graphite) gets lost or at least decreases, causing a reduced conductivity. The provision of soot is also disadvantageous because it is prone to wear off, as the corona shield is handled, so as to produce rubbings which also adversely affect the electric conductivity.

Outer corona shields are typically made to date, as stated above, by using soot-containing or graphite-containing fabric bands or varnishes. The VPI impregnation process uses fabric bands or non-woven bands on the basis of glass or polyester which are provided with organic binder to comply with requirements for conductive filler material. In winding elements which are made by single rod impregnation or RR-process, the outer corona shielding is made with varnish-based filler-containing coats. As a consequence of the required use of organic binder and its limited resistance to thermal stress (up to about 180°), the used materials will be destroyed by partial discharges. In addition, the electric conductivity is adversely affected by the VPI impregnation process, and, moreover, soot particles or graphite particles are inadvertently carried away by the impregnating resin, thereby contaminating the electrically conductive fillers and the quality of the impregnation.

The use of organic material is also disadvantageous because of the adverse impact of ozone that is produced during partial discharges. Ozone destroys organic material, e.g. resin as binder for SiC or also soot or graphite. As a result of the destruction of the organic material, partial discharges in the electric machine increase further on the conductors, thereby forming even more ozone that leads to the increasing destruction of the organic material, ultimately causing a breakdown of the electric machine. Soot or graphite has been added to resin heretofore for soaking a glass fabric or a polyester fabric. To increase the electric conductivity, silicon carbide is added. The use of organic resin for soaking glass fabrics or polyester fabrics limits, however, the maximum temperature at which the electric machine can operate properly. The ozone generated by partial discharges also destroys the soot or graphite contained in the organic resin so that the electric conductivity of the corona shield decreases and the organic resin increasingly dissolves, ultimately destroying the corona shield.

It would therefore be desirable and advantageous to provide an improved corona shield for an electric machine to obviate prior art shortcomings and to exhibit reproducible electric properties while having extended service life and producible in a simple and cost-efficient manner.

### SUMMARY OF THE INVENTION

According to one aspect of the present invention, a corona shield for an electric machine includes a substrate; and a coating applied on the substrate.

Production of a corona shield according to the invention involves, for example, the use of a glass fabric of inorganic material as base material which is electrically non-conductive and soaking it in a solvent. The solvent may contain, for example, metal-organic and/or inorganic transition metals. After evaporation of the solvent, the impregnated glass fabric is calcinated at a temperature of about 600° C. The electric conductivity can be set for example by the thickness and by the doping of the antimony-mixed stannic oxide layer on the surface.

As the corona shield is comprised of a substrate (carrier material) and an applied coating, the functions of the corona shield can be suited to the situation at hand and separated from one another. While the substrate provides primarily the mechanical property of the corona shield, the coating provides primarily the electric property of the corona shield. The coating contains electrically conductive inorganic material which is much less sensitive to partial discharges. Thus, a corona shield according to the present invention, i.e. substrate and coating, is made entirely of inorganic material. Of course, there may be a situation, when the substrate may include organic compounds such as, for example, application of an adhesive at the beginning and end of a corona shield for securement to an insulation. This, however, does not adversely affect the reliability of the corona shield.

According to another feature of the present invention, the substrate may be a non-woven fabric and/or a fabric. Generally, any electrically insulating inorganic types of fabric may be used as substrate so long as they remain stable in the required temperature range of the electric machine. Currently preferred is a substrate in the form of glass fabric or fabric of aluminum oxide (AlO) or fabric of aluminum oxide which contains also silicon dioxide (SiO₂).

According to another aspect of the present invention, a corona shield for an electric machine includes a substrate having filaments which contain electrically conductive inorganic material and have a coating of electrically conductive inorganic material. The substrate may be a fabric made of threads or a non-woven fabric made of fibers as filaments.

In this application, the term “filament” as referred to throughout this disclosure is used here in a generic sense and covers any thin continuous object such as, e.g., thread, strand, string or fiber.

Analogous to a coating of the substrate, coating of the filaments involves the application of electrically conductive inorganic material on at least parts thereof. When the corona shield is made of filaments that are coated with electrically conductive inorganic material, there is no need to additional apply a coat on the substrate (fabric or non-woven). Adjustment of the electric conductivity can be realized by mixing electrically conductive filaments with electrically non-conductive filaments.

A corona shield finds application in particular for protecting the insulation of electric machines, such as motors, e.g. rail traction motors, and generators, in particular turbo generators at voltages in kV range, especially greater or equal 3.3 kV. When voltage of greater than 3.3 kV is applied, care should be taken to prevent partial discharge or glow discharge and to provide corona shielding. In this context, the terms “inner corona shield” or “outer corona shield” refer to the slot area of a laminated core of an electric machine, while the term “end corona shield” relates to the area of the winding end portion.

A corona shield according to the present invention may be realized in the form of a fabric band or non-woven band. The band can be made from electrically conductive endless fibers or staple fibers. The required electric conductivities for inner corona shielding and outer corona shielding (5*10² Ω/squared to 5*10⁴ Ω/squared) and for the end corona shielding (5*10⁷ Ω/squared to 5*10⁹ Ω/squared) can be realized by different doping, i.e. through different concentrations or also different layer thicknesses of the electrically conductive materials.

As a result of a use of thermally stable inorganic materials, the corona shield accordance to the invention is temperature-resistant to a temperature of up to 500° C. Thus, an electric machine can be subjected to higher loads as far as end corona shielding and outer corona shielding are concerned, so that the electric machine can run efficiently for higher thermal tasks as well as higher electric tasks. The conductivity of the fabric or non-woven remains unaffected by a VPI-impregnation process. Contamination of the VPI impregnation fluid through electrically conductive components of the corona shield (fillers) is of no concern because of the absence of any electrically conductive fillers in an organic carrier material and because the electrically conductive coating firmly adheres to the inorganic substrate.

Corona shielding is of particular relevance in electric machines in addition to its function as insulation. This is true especially for high-voltage machines at a voltage from about 3.3 kV. Three parameters are relevant for developing insulation system for machines:
thermal stability,
thermal heat conductivity, and
electric properties.

Electric properties involve electric resistance as well as distribution of electric field strengths. In particular, when high-voltage machines are involved, mica based insulation systems are used. Mica allows realization of maximum field strength of about 3.5 kV/mm. The insulation of conductors in electric machines can be so constructed that the conductor is enclosed by an insulating layer which in turn is wrapped by a corona shield as additional layer. The corona shield assists in the implementation of an even field distribution on the surface of the conductor. Moreover, the corona shield demarcates within the electric machine the stator slots of the laminated stator core. The laminated stator core is for example set to zero potential or to neutral potential. The outer corona shielding has different electric properties than the end corona shielding. The insulation as well as the corona shield of an electric machine is dependent on the use of the electric machine. In particular, when operating an electric machine on power converters which execute a pulse modulation, the insulation and the corona shield has to satisfy higher requirements.

As a consequence of using a coating of electrically conductive inorganic material for a corona shield according to the invention, the drawback experienced in connection with using soot or graphite upon exposure to partial discharges is eliminated. As the substrate as well as the applied coating is made of inorganic material, the corona shield according to the invention exhibits enhanced temperature resistance and is insensitive to ozone produced by partial discharge.

Examples of inorganic substrate for coating include glass, aluminum oxide (AlO), and silicon carbide (SiC), for making a non-woven or a fabric.

A corona shield according to the invention may be constructed for use as outer corona shielding (OCS) or for use as end corona shielding (ECS) with different electric properties. An end corona shield may hereby have a resistance value of 5×10⁸ Ω/m, whereas an outer corona shield may have a typical resistance value of 1000 Ω/m. In general the resistance value will depend however on many factors which may involve voltage or length of an end corona shield. The corona shield, regardless whether for outer corona shielding or end corona shielding, can be provided for potential equalization on the surface of the primary insulation. Thus, resistance values are possible which differ from the above standard values. The corona shield further provides a homogenization of the electric field. An end corona shield provides a lowering of the potential of the laminated stator core of the electric machine. Field strengths encountered in air upon the conductor with attached corona shield are now prevented from causing arcing.

By using different coatings of a substrate, the construction of an outer corona shielding and end corona shielding can be best suited to the situation at hand as the corona shield differs only by the selected coating while the substrate material remain the same.

As described above, a corona shield according to the present invention is especially applicable for electric high-voltage machines, which are typically operated at a voltage above 3 kV, in order to effect a potential equalization on the conductors.

According to another aspect of the present invention, a method of making a corona shield includes the step of coating a substrate. The coating step may hereby be realized in many different ways. For example, spray coating may be used by which the inorganic coat is sprayed onto the inorganic substrate. As the inorganic coating is partly or entirely electrically conductive, a corona shield is made which is inorganic. Solvents for spray coating may include alcohol which may also be organic. An organic solvent evaporates and thus does not form a component of the corona shield. As an alternative to spray coating, application of the coating may also be realized though deposition by evaporation by which the coating of electrically conductive inorganic material is formed on the substrate.

Instead of coating the substrate, it is also possible to coat individual filaments or rovings (twisted strand of filaments). Coating may be realized through deposition by evaporation, or by spray coating, or by guiding the filaments through a liquid immersion bath. The use of an immersion bath may also be used for coating the substrate, e.g. glass fabric.

Manufacture of insulation bands for corona shielding layers for windings of electric machines is carried out by coating a fabric-like substrate with a solution, a sol, or a suspension to provide electron conductivity. This represents an alternative to the realizing of electron conductivity through spray coating, dip coating or flame coating.

The electron conducting coatings for manufacturing insulation bands for use as corona shielding are kept at a temperature from 350° C. to 700° C., thereby producing coherent and electrically conductive coatings that adhere to the surface of the fabric. This type of thermal treatment can be carried out in different atmospheres, e.g. air, forming gas, N₂, NH₃, in a furnace which can be heated electrically or using fossil fuels, or through exposure to an infrared radiator and/or different radiation sources, e.g. laser.

All these processes allow implementation of an electron conducting coating upon the substrate as well as upon the filaments. This coating may be made, for example, of metal oxides, primarily indium oxide, stannic oxide, arsenic oxide, antimony oxide, transition metal oxides, or any combinations thereof.

Examples of starting compounds for the manufacture of the coating of insulating bands for corona shielding layers include inorganic salts or complex compounds of metals, primarily indium, tin, arsenic, and antimony, preferably acetate, alcoholates, acetyl acetonates, oxalates, halogenides, nitrates, sulfates. Also suspensions of smallest particles of metal oxides, primarily indium oxide, stannic oxide, arsenic oxide, antimony oxide, transition metal oxides are applicable.

The resistance of the coating can be adjusted by the thickness of the coating but also by a differentiated selection of electrically conductive materials in the coating as well as by their concentration. Using immersion process in a solution, a sol, or a suspension for making a coating, the thickness of the coating can be adjusted, for example, by the speed by which the object being coated travels through the immersion bath.

When repeatedly applying a coating process, the coating may include more than one layer. In particular when coating of a filament or band-shaped substrate is involved, a multiple application of the coating process can be utilized to form an adhesive layer to enhance the adhesion between the electrically conductive coating and the substrate layer or the uncoated filament. Several coats are also advantageous to provide a balance between different thermal expansion coefficients.

As described above, a coating can be applied by the following processes:

Spray Coating:

A solution, a sol, or a suspension is sprayed by a spraying unit onto a band as substrate. Suitably, the band is guided to move past the spraying unit. Spray coating may take place on only one side or simultaneously or almost simultaneously on both sides.

Dip Coating:

A glass fabric band as substrate is immersed in a solution, a sol, or a suspension and subsequently withdrawn, suitably at constant speed, thereby forming an adhering layer of constant thickness. The process is suitably carried out continuously, with the glass band being guided, suitably at constant speed, through the coating bath which contains the solution, sol, or suspension.

Flame Coating:

A solution, a sol, or a suspension is sprayed into a flame which points towards the substrate in the form of a glass fabric band, thereby forming a uniform oxidic coating on the band. Flame coating may take place on only one side or simultaneously or almost simultaneously on both sides. The flame may be a gas flame or a flame of combustible liquids which may be the solution itself being sprayed on. Also a plasma flame is applicable. The glass fabric band may hereby be at room temperature or may be heated to a temperature of up to 500° C.

Another coating process that is applicable here involves sputtering.

Following a preceding coating process, a thermal treatment may be applied. A coating obtained by one of the preceding processes is heated to a temperature between 350° C. and 700° C. depending on the coat composition and coating process. The thermal treatment is carried out under air atmosphere or under inert gas but may also be executed in a reactive atmosphere, e.g. forming gas, NH₃ or CH₄.

The application of a thermal aftertreatment is generally desirous when dip coating or spray coating is involved, while generally not required when flame coating is involved. Thermal aftertreatment is carried out in an electrically heated furnace or in a furnace operated by gaseous or liquid fossils. Infrared radiators and/or other radiation sources or a combination of these heat sources may be useable as well.

The thermal aftertreatment may be carried out discontinuously or continuously, with the substrate, e.g. a glass band after coated, being drawn through a furnace. The furnace may be operated at a locally constant temperature or subdivided in zones of different temperature. This allows a thermal treatment of the passing band in the form of a defined temperature-time characteristic.

The coating process results in a particular composition of the coating. Preferred are inorganic oxidic layers. For example, the layers may be made of doped titanium oxide or stannic oxide. Examples of dopants include Sb₂O₅, Nb₂O₅, Ta₂O₅, or V₂O₅. The use of undoped layers of TiO₂ or SnO₂ may also be possible if exhibiting a sufficient electron conductivity after addition of reducing components and/or reducing gas atmospheres during thermal aftertreatment. Also other oxidic coatings, such as Nb₂O₅, MoO₂ or Ta₂O₅ may be used. These layers may be doped as well. Another option involves the use of electronically conducting In₂O₃ layers which may be doped with up to 50 weight % of SnO₂, preferably 2-5 weight-% of SnO₂. Examples of further oxidic layers include CuO, MnO, NiO, CoOₓ, FeOₓ as well as mixtures or compounds of oxides thereof. Thus, the use of transition metal oxide, arsenic oxide, indium oxide, antimony oxide and stannic oxide or any combinations thereof or compounds from oxides is generally possible.

The coating solution may be realized by any solution to satisfy the requirements of the above-described coating processes. Examples of solutions include inorganic salts or complex compounds of the afore-mentioned metals. Preferred here are halogenides, sulfates, nitrates, acetates, oxalates, acetyl acetonates, or salts of other organic acids. Alcoholates of the respective metal can be used as well. The solutions may be aqueous solutions or alcoholic solutions, both of which may contain organic additives. Also possible is the use of organic solutions, soles which contain the respective metal components. Examples include soles that have been made according to the sol-gel process from alcoholates or halogenides or acetates or other salts of organic acids.

Another option is the use of suspensions of smallest particles in water or organic solvents. The particle size may hereby range from few nm to few micrometers. Preferred is the use of particle sizes in the range of 5 nm to 200 nm. The use of oxidic or hydroxic particles or particles of chemical compounds which react into oxides during thermal treatment may hereby be involved. Examples include carbonates, acetates or oxalates. Optionally, the suspensions may contain stabilizers or other additives of organic or inorganic components.

Following the thermal treatment, a layer of an organic polymer may be applied as protective layer which, however, does not adversely affect the electric properties of the corona shield.

### EXAMPLE 1

The following description relates to an outer corona shield band of glass fabric which is coated with antimony-doped stannic oxide (5 mol-%):

The sole for coat application is made from SnCl₂*2H₂O. 50.77 g (0.255 mol) of SnCl₂*2H₂O (M 225.63) are dissolved in 600 ml of absolute ethanol and subsequently heated for 2 h in a flask with return condenser and attached dry tube with backflow. The solvent is distilled off and the residue in the form of a white powder is absorbed again with 300 ml of absolute ethanol. The resultant solution is stirred for 2 h at a temperature of 50° C. After a cool-down period, 2.57 g (0.011 mol) of SbCl₃ (M 228.11), dissolved in few milliliters of absolute ethanol, is slowly added in drops under stirring. Care should be taken that no remaining precipitation develops. After the solution has been aged for several days, the glass fabric band is drawn through the solution at a constant speed of 20 cm/min. The coating is dried for 15 min. at 110° C. and subsequently burnt in at 500° C. for 20 min. A transparent, electrically conductive coating is obtained having the following reproducible properties:

Layer thickness: 80-100 nm

Layer resistance: 900 Ω/squared-4.0 kΩ/squared.

### EXAMPLE 2

The following description relates to an outer corona shield band of glass fabric which is coated with tin-doped indium oxide (5 mol-%):

The solution for coat application is made from In(NO₃)₃*(H₂O)₅. 45.12 g (0.15 mol) of In(NO₃)₃*(H₂O)₅ (M 300.83) are dissolved in 300 ml of absolute ethanol together with 30.90 ml (0.30 mol) of acetyl acetone (M 100.12). 1.69 g (0.0075 mol) of SnCl₂*2H₂O (M 225.63) are directly added under stirring into the solution. After the resultant solution has been aged, the glass fabric band is drawn through the solution at a constant speed of 30 cm/min. The coating is dried for 15 min. at 110° C. and subsequently burnt in at 500° C. for 20 min. A transparent, electrically conductive coating is obtained having the following reproducible properties:

Layer thickness: 90-110 nm

Layer resistance: 3 kΩ/squared-8 kΩ/squared.

### EXAMPLE 3

The following description relates to an outer corona shield band of glass fabric which is coated with fluorine-doped stannic oxide (5 mol-%):

The sole for coat application is made from SnCl₂*2H₂O. 60.92 g (0.27 mol) of SnCl₂*2H₂O (M 225.63) are dissolved in 600 ml of absolute ethanol and subsequently heated for 2 h in a flask with return condenser and attached dry tube with backflow. The solvent is distilled off and the residue in the form of a white powder is absorbed again with 300 ml of absolute ethanol. The resultant solution is stirred for 2 h at a temperature of 50° C. After a cool-down period, 0.34 ml (0.0043 mol) of CF₃COOH (M 114.03) is slowly added in drops under stirring. Care should be taken that no remaining precipitation develops. After the solution has been aged for several days, the glass fabric band is drawn through the solution at a constant speed of 10 cm/min. The coating is dried for 15 min. at 110° C. and subsequently burnt in at 500° C. for 30 min. A transparent, electrically conductive coating is obtained having the following reproducible properties:

Layer thickness: 100-110 nm

Layer resistance: 30 kΩ/squared-60 kΩ/squared.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a fragmentary perspective illustration of a laminated stator core equipped with a corona shield according to the present invention for insulating a conductor;

FIG. 2 is a detailed view of a substrate with a coating;

FIG. 3 is a fragmentary sectional view showing in detail an exit area of the conductor from the laminated stator core;

FIG. 4 is a graphical illustration showing the relation between conductivity as a function of the concentration of electrically conductive substances;

FIG. 5 is a schematic illustration of one variation of a fabric for a corona shield according to the present invention;

FIG. 5a is a schematic illustration of another variation of a fabric for a corona shield according to the present invention;

FIG. 6 is a schematic illustration of a coated filament; and

FIG. 7 is a schematic illustration of a coating device for making a corona shield according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have different inventive entity. Both applications are unique, but incorporate the other by reference. Accordingly, the following U.S. patent application is hereby expressly incorporated by reference: “Corona Shield, and Method of Making a Corona Shield”.

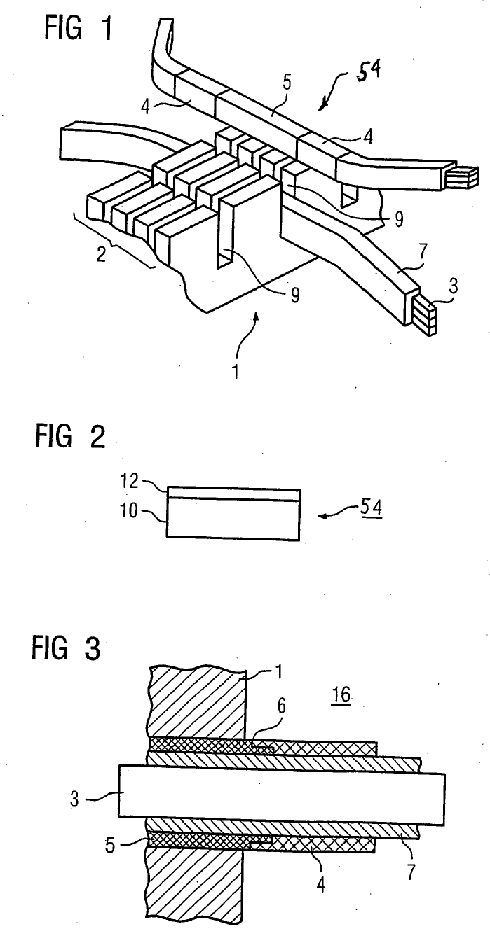

Turning now to the drawing, and in particular to FIG. 1, there is shown a fragmentary perspective illustration of a laminated stator core, generally designated by reference numeral 1 and forming part of an electric machine which further includes an unillustrated rotor which rotates within the stator core 1. The stator core 1 is made up of a certain number of stacked laminations 2 in which stator slots 9 are preformed through punching for receiving a stator winding which is provided with a particular insulation system to suit a certain need. The stator winding may be formed by insulated windings or copper conductors 3. A typical insulation system for high-voltage machines includes a main insulation 7, also referred to in the following as conductor insulation which is wrapped by band-like coronal shield, generally designated by reference numeral 54. The corona shield 54 includes hereby an outer corona shield 5 for wrapping the area of the copper conductor 3 within the stator core 1, and an end corona shield 4 for wrapping the area of the copper conductor 3 outside the stator core 1.

When high-voltage machines of >3.3 kV are involved, e.g. rail machines or high-voltage machines that are powered by converters and thermally highly utilized machines such as e.g. ail traction motors, the surface of the stator insulation is provided in the slot area with an elecetrically well-conducting outer corona shield (OCS) 5 to protect the insulation from damages as a result of excessive partial discharges. The outer corona shield 5 extends hereby beyond the laminated stator core 1 so as to prevent the occurrence of discharges even at a small distance to the pressure plates and pressure fingers. Through application of an impregnation process (VPI process), the windings are soaked with an impregnating resin which is then cured. In other words, the used outer band-like corona shield 5 must be compatible with this complex process. The band should therefore be free of any constituents that could adversely affect the impregnation process or are discharged in the impregnating bath. In addition, the band should be evenly integrated into the formed product after curing to avoid partial discharges.

In accordance with the present invention, the outer band-like corona shield 5 as well as the end band-like corona shield 4, as shown in FIG. 1, can be made available in reproducible quality, whereby the main insulation 7 is reliably protected from partial discharges and the quality of the remaining insulation is not adversely affected. Moreover, the corona shield 54 has a thermal stability which is significantly higher in comparison to conventional band-like corona shields.

FIG. 1 illustrates an exemplary application of the corona shield 54. The stator core 1 is made up of laminations 2 having the stator slots 9 for receiving the copper conductors 3 which are wrapped by insulation 7. The conductor insulation 7 is constructed stronger inside the stator core 1 than on the outside of the stator core 1, where the copper conductors 3 form a winding overhang (not shown in FIG. 1). Attached to the insulation 7 of the copper conductor 3 is the corona shield 54 for insulating the copper conductor 3, with the outer corona shield 5 wrapping the area of the copper conductor 3 within the stator core 1, and the end corona shield 4 wrapping the area of the copper conductor 3 outside the stator core 1. The outer corona shield 5 as well as the end corona shield 4 control the electric potential.

The corona shield 54 is made of a substrate (carrier layer) which is coated by a further layer to provide electric conductivity through inclusion of electrically conductive inorganic material. Although not shown in detail, it is, of course, conceivable to provide the corona shield 54 with more than one substrate and/or more than one further layer. The substrate may be realized by a fabric having threads which contain the electrically conductive inorganic material or by a non-woven fabric having fibers which contain the electrically conductive inorganic material.

Turning now to FIG. 2, there is shown a detailed schematic illustration of a corona shield 54 having a substrate or carrier material 10 and a coating 12. Depending on the application of the corona shield 54, i.e. as outer corona shield 5 or as end corona shield 4, the substrate 10 and the coating 12 are constructed differently, e.g. different thickness. The substrate 10 may be made of fibers of glass for making a fabric, e.g., through linen weave with wefts and warps. Stability and flexibility can be adjusted in dependence on the selected weave type. In general, the fabric should be made as thin as possible. The fabric structure is also relevant to influence a smoothing of the field. The coating 12 includes electrically conductive inorganic substances. Examples of conductive inorganic materials include metals of different oxidation stages. As the outer corona shield 5 has a higher electric conductivity compared to the end corona shield 4, a higher concentration of metals of different oxidation stages within the corona shield allows a change of an end corona shield to an outer corona shield

FIG. 3 shows in more detail a transition zone of the copper conductor 3 from the stator core 1 to an area of air 16 to illustrate the insulation 7 and the corona shield 54 with both outer corona shield 5 and end corona shield 4 which are placed in overlapping relationship in a jointing area 6. The stepped connection between the outer corona shield 5 and the end corona shield 4 is realized by winding the corona shield 54 as band onto the insulation 7 of the copper conductor 3 half overlappingly so that the corona shield 54 is wrapped about the insulation 7 in two layers for example. Of course, other winding processes known to the artisan are possible as well in order to effect a single-layer or multi-layer wrapping by a band.

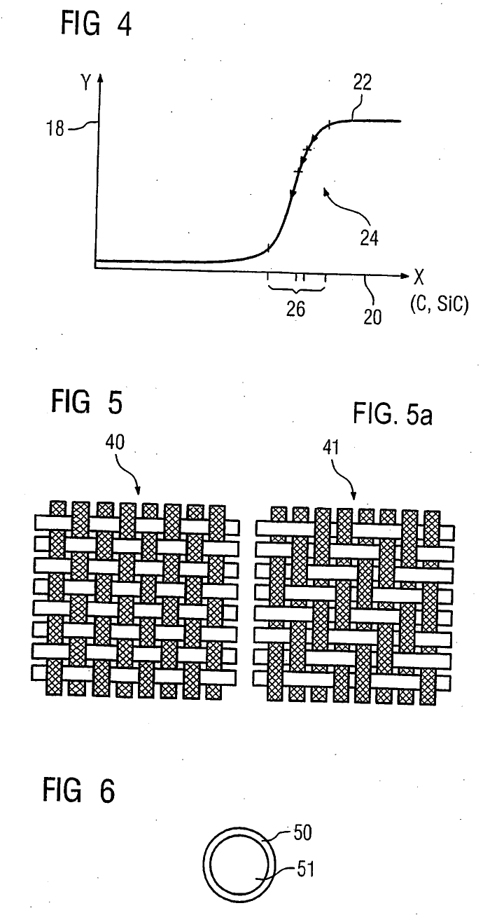

Turning now to FIG. 4, there is shown a graph 22 illustrating the relation between conductivity on the y-axis 18 as a function of the concentration of electrically conductive substances on the x-axis 20. Examples of an electrically conductive material include carbon or silicon carbide. The graph 22 illustrates a steep ascent 24 within a narrow range 26 in which the concentration changes. This illustrates the problems faced by the prior art to adjust the concentration of conductive materials through impregnation of a carrier material. Dripping or condensation easily results in a shift of the concentration and ultimately to a substantial change in the conductivity. A further problem encountered heretofore is the damage to prior art corona shield as a result of ozone generated by a partial discharge, resulting in a substantial change in conductivity. As a result of using inorganic material in accordance with the present invention for constructing the substrate and the further layer of the corona shield 54 and the provision of an electric conductivity through provision of the electrically conductive material within the further layer, the afore-stated problems are overcome.

FIG. 5 shows a fabric 40 made through linen weave, and FIG. 4a shows a fabric 41 made through twill weave. Both weave types are to be understood as examples only for a fabric to form a substrate for a further layer, or for a fabric having coated filaments. FIG. 6 shows a schematic view of a coated filament having an inner glass fiber 51 to represent the filament core, and an outer coating 50.

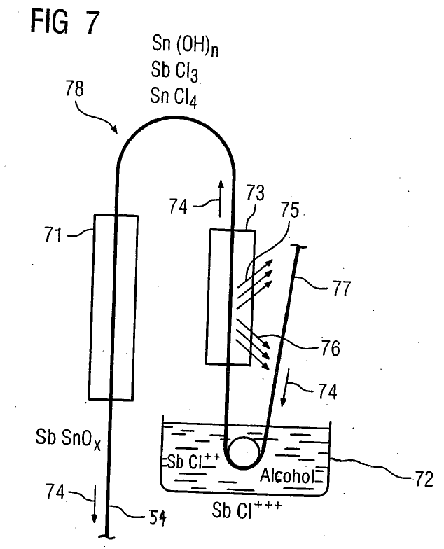

Referring now to FIG. 7, there is shown, by way of example, a schematic illustration of a coating device, generally designated by reference numeral 78, for making a corona shield 54 according to the present invention. The coating device 78 uses dip coating with subsequent calcination (heat treatment). The process is as follows: A webbed substrate 77 is coated with a solution, sol or suspension in a liquid bath 72. The movement direction of the substrate 77 is indicated by arrow 74. The liquid bath 71 contains various inorganic materials which are dissolved in alcohol and deposit on the substrate 77. Any inorganic material can be selected which exhibit electronically conductive properties either inherently or following a thermal aftertreatment. Alcohol is removed in an intermediate treatment unit 73, for example by applying an elevated temperature to form vapor, as indicated by arrows 75 and/or by dripping, as indicated by arrows 76. Calcination is realized during a subsequent thermal aftertreatment in a heater 71 through which the coated substrate 77 moves and is exposed to a temperature between 350° C. and 700° C., thereby producing an adherent, coherent and electrically conductive coating on the surface of webbed substrate 77. The thickness of the coating amounts to few nm up to few micrometer, preferably 50 nm to 500 nm.

The substrate may be made of any electrically insulating inorganic fabric type available to the artisan and resistant in the afore-described temperature range. Currently preferred is the use of glass fabric or fabric of aluminum oxide or fabric of aluminum oxide containing SiO₂.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A corona shield for an electric machine, comprising a substrate; and a coating applied on the substrate.

2. The corona shield of claim 1, wherein the substrate and the coating are made of inorganic material.

3. The corona shield of claim 1, wherein the coating has a thickness in a range of 50 nm to 500 nm.

4. The corona shield of claim 1, wherein the coating is made of inorganic oxidic layers.

5. The corona shield of claim 4, wherein the inorganic oxidic layers include a material selected from the group consisting of doped titanium oxide, stannic oxide, Nb₂O₅, MoO₂, Ta₂O₅, In₂O₃, SnO₂-doped In₂O₃, CuO, MnO, NiO, CoOₓ, FeOₓ and mixtures or compounds of oxides thereof.

6. The corona shield of claim 5, wherein the dopant is selected from the group consisting of Sb₂O₅, Nb₂O₅, Ta₂O₅, and V₂O₅.

7. The corona shield of claim 4, wherein the coating is made of undoped layers of TiO₂ or SnO₂.

8. The corona shield of claim 1, wherein the coating is made of a material selected from the group consisting of transition metal oxide, arsenic oxide, indium oxide, antimony oxide, stannic oxide and combinations thereof.

9. The corona shield of claim 1, wherein the substrate is a non-woven fabric and/or a fabric.

10. The corona shield of claim 1, wherein the substrate is made of glass.

11. The corona shield of claim 1, wherein the substrate is made of silicon carbide.

12 The corona shield of claim 1, wherein the substrate is made of aluminum oxide (AlO).

13. The corona shield of claim 1, wherein the substrate contains silicon dioxide.

14. The corona shield of claim 1 for use as outer corona shield.

15. The corona shield of claim 1 for use as end corona shield.

16. A corona shield for an electric machine, comprising a substrate having filaments which contain electrically conductive inorganic material and have a coating of electrically conductive inorganic material.

17. The corona shield of claim 16, wherein the substrate is a fabric made of threads as filaments.

18. The corona shield of claim 16, wherein the substrate is a non-woven fabric made of fibers as filaments.

19. The corona shield of claim 16, wherein the substrate is a combination of a fabric made of threads as filaments and a non-woven fabric made of fibers as filaments.

20. The corona shield of claim 16, wherein the filaments have a core which is made of a material selected from the group consisting of glass, silicon carbide, and aluminum oxide.

21. The corona shield of claim 16, wherein the coating includes at least one electrically conductive inorganic material.

22. The corona shield of claim 16, wherein the coating has a thickness in a range of 50 nm to 500 nm.

23. The corona shield of claim 18, wherein the electrically conductive inorganic material is antimony-doped stannic oxide.

24. The corona shield of claim 16 for use as outer corona shield.

25. The corona shield of claim 16 for use as end corona shield.

26. The corona shield of claim 16 for use in an electric high-voltage machine.

27. A method of making a corona shield, comprising the step of coating a substrate.

28. The method of claim 27, wherein the coating step includes a process selected from the group consisting of spray coating, dip coating, and flame coating.

29. A method of making a corona shield, comprising the step of adding a coating onto a filament or roving:

30. The method of claim 29, wherein the coating step includes a process selected from the group consisting of spray coating, dip coating, and flame coating.

31. An electric machine, comprising a corona shield having a substrate; and a coating on the substrate.

32. An electric machine, comprising a corona shield having a substrate having filaments which contain electrically conductive inorganic material and have a coating of electrically conductive inorganic material.

33. A method of making a corona shield, comprising the steps of:
providing a glass fabric of inorganic material as base material which is electrically non-conductive;
soaking the glass fabric in a solvent;
allowing the solvent to evaporate; and
calcinating the impregnated glass fabric at a temperature of about 600° C.

34. The method of claim 28, wherein the solvent contains metal-organic and/or inorganic transition metals.
